(19) United States
(12) Patent Application Publication
(10) Pub. No.: US 2015/0308720 A1
(43) Pub. Date: Oct. 29, 2015

(54) ABSORPTION HEAT PUMP AND SORBENT FOR AN ABSORPTION HEAT PUMP COMPRISING METHANESULFONIC ACID

(71) Applicants: Olivier ZEHNACKER, Dortmund (DE); Rolf SCHNEIDER, Gruendau-Rothenbergen (DE); Marc-Christoph SCHNEIDER, Offenbach (DE); Matthias SEILER, Duesseldorf-Unterbach (DE); Xinming WANG, Kanagawa-ken (JP)

(72) Inventors: Olivier ZEHNACKER, Dortmund (DE); Rolf SCHNEIDER, Gruendau-Rothenbergen (DE); Marc-Christoph SCHNEIDER, Offenbach (DE); Matthias SEILER, Duesseldorf-Unterbach (DE); Xinming WANG, Kanagawa-ken (JP)

(73) Assignee: EVONIK DEGUSSA GMBH, Essen (DE)

(21) Appl. No.: 14/646,516

(22) PCT Filed: Nov. 5, 2013
(86) PCT No.: PCT/EP2013/072972

§ 371 Date: May 21, 2015

(30) Foreign Application Priority Data
Nov. 21, 2012 (EP) 12193565.4

(51) Int. Cl. F25B 15/02; C09K 5/10

(52) U.S. Cl. CPC F25B 15/02; C09K 5/10

(57) ABSTRACT

The invention relates to the use of methanesulphonic acid as sorption medium in an absorption heat pump; a sorption medium for an absorption heat pump which comprises methanesulphonic acid and an ionic liquid; and an absorption heat pump having an absorber, a desorber, a condenser, an evaporator and a working medium comprising a volatile refrigerant and a sorption medium, wherein the sorption medium comprises methanesulphonic acid.

The invention relates to absorption heat pumps and sorption media for absorption heat pumps, which sorption media comprise methanesulphonic acid.

Classical heat pumps are based on a circuit of a refrigerant via an evaporator and a condenser. In the evaporator, a refrigerant is vaporized, with heat being withdrawn from a first medium by the heat of vaporization taken up by the refrigerant. The vaporized refrigerant is then brought by means of a compressor to a higher pressure and condensed in the condenser at a temperature higher than that in the vaporization, with the heat of vaporization being liberated again and heat being passed to a second medium at a higher temperature level. The liquefied refrigerant is subsequently depressurized again to the pressure of the evaporator.

Classical heat pumps have the disadvantage that they consume a great deal of mechanical energy for compression of the gaseous refrigerant. On the other hand, absorption heat pumps have a reduced demand for mechanical energy. Absorption heat pumps have a sorption medium, an absorber and a desorber in addition to the refrigerant, evaporator and condenser of a classical heat pump. The vaporized refrigerant is absorbed in the sorption medium in the absorber at the pressure of the vaporization and is subsequently desorbed again from the sorption medium in the desorber by supply of heat at a pressure higher than that of the condensation. The compression of the liquid working medium composed of refrigerant and sorption medium requires less mechanical energy than the compression of the refrigerant vapour in a classical heat pump, and the consumption of mechanical energy is replaced by the heat energy used for desorption of the refrigerant. The efficiency of an absorption heat pump is calculated as the ratio of the heat flow utilized for cooling or heating to the heat flow supplied to the desorber for operation of the absorption heat pump and is referred to as “coefficient of performance”, abbreviated to COP.

A large part of the absorption heat pumps used industrially use a working medium which contains water as refrigerant and lithium bromide as sorption medium. However, this working medium has the disadvantage that the water concentration must not go below from 35 to 40% by weight in the working medium since otherwise crystallization of lithium bromide and as a result malfunctions can occur to the point of solidification of the working medium.

In WO 2005/113702 and WO 2006/134015, it was proposed to use working media containing an ionic liquid having organic cations as sorption medium in order to avoid malfunctions caused by crystallization of the sorption medium. These working media have the disadvantage that they have an undesirably high viscosity at a low content of refrigerant.

Working media containing sulphuric acid as sorption medium likewise have the disadvantage that they have an undesirably high viscosity at a low content of refrigerant. In addition, they are also very corrosive.

There is therefore a continuing need for sorption media for absorption heat pumps, by means of which a good efficiency of the absorption heat pump can be achieved without problems due to crystallization of the sorption medium occurring and as a result of which the working medium at the same time has a low viscosity and manageable corrosiveness.

It has now been found that this combination of properties can be achieved by the use of methanesulphonic acid as sorption medium, in particular by the use of methanesulphonic acid in combination with an ionic liquid.

The invention accordingly provides an absorption heat pump comprising an absorber, a desorber, a condenser, an evaporator and a working medium, wherein the working medium comprises a volatile refrigerant and a sorption medium and the sorption medium comprises methanesulphonic acid.

The invention additionally provides a sorption medium for an absorption heat pump, which comprises methanesulphonic acid and an ionic liquid.

The invention further provides for the use of methanesulphonic acid as sorption medium in an absorption heat pump.

For the purposes of the invention, the term absorption heat pump encompasses all apparatuses by means of which heat is taken up at a low temperature level and is released again at a higher temperature level and which are driven by supply of heat to the desorber. The absorption heat pumps of the invention thus encompass both absorption refrigeration machines and absorption heat pumps in the narrower sense in which absorber and evaporator are operated at a lower working pressure than the desorber and condenser, and also absorption heat transformers in which absorber and evaporator are operated at a higher working pressure than the desorber and condenser. In absorption refrigeration machines, the uptake of heat of vaporization in the evaporator is utilized for cooling a medium. In absorption heat pumps in the narrower sense, the heat liberated in the condenser and/or absorber is utilized for heating a medium. In absorption heat transformers, the heat of absorption liberated in the absorber is utilized for heating a medium, with the heat of absorption being obtained at a higher temperature level than that in the supply of heat to the desorber.

The absorption heat pump of the invention comprises an absorber, a desorber, a condenser, an evaporator and a working medium which comprises a volatile refrigerant and a sorption medium.

During operation of the absorption heat pump of the invention, gaseous refrigerant is absorbed in refrigerant-depleted working medium in the absorber to give a refrigerant-rich working medium with liberation of heat of absorption. Refrigerant is desorbed in vapour form from the resulting refrigerant-rich working medium with supply of heat in the desorber to give refrigerant-depleted working medium which is recirculated to the absorber. The gaseous refrigerant obtained in the desorber is condensed in the condenser with liberation of heat of condensation, the liquid refrigerant obtained is vaporized in the evaporator with uptake of heat of vaporization and the gaseous refrigerant obtained is recirculated to the absorber.

In a preferred embodiment, the absorption heat pump is an absorption refrigeration machine and heat is taken up in the evaporator from a medium to be cooled.

The working medium of the absorption heat pump of the invention comprises a volatile refrigerant and a sorption medium comprising methanesulphonic acid. Suitable volatile refrigerants are materials which have a boiling point in the range from −90 to 120° C. and do not react irreversibly with methanesulphonic acid. The working medium of the absorption heat pump of the invention preferably comprises water as refrigerant.

In a preferred embodiment, the combined proportion of water and methanesulphonic acid in the absorption medium is greater than 90% by weight.

In another preferred embodiment, the sorption medium comprises methanesulphonic acid and an ionic liquid. The weight ratio of methanesulphonic acid to ionic liquids is preferably in the range from 9:1 to 1:100. At a high weight ratio of methanesulphonic acid to ionic liquid, preferably in the range from 9:1 to 1:4 and particularly preferably in the range from 9:1 to 1:1, a lower vapour pressure of the refrigerant at the temperature required in the absorber and a high vapour pressure difference at the temperatures required for absorber and desorber can be achieved. Even at a low weight ratio of methanesulphonic acid to ionic liquid, preferably in the range from 1:1 to 1:100, particularly preferably from 1:4 to 1:100 and most preferably in the range from 1:10 to 1:100, a significantly lower viscosity and an improved thermal stability of the working medium can be achieved compared to working media which contain only ionic liquid as sorption medium. In addition, at a weight ratio of methanesulphonic acid to ionic liquid in the range from 9:1 to 1:10, preferably from 1:1 to 1:10 and particularly preferably from 1:1 to 1:4, nonideal behaviour of the vapour pressure with an increased vapour pressure at the temperature required in the desorber is surprisingly achieved for working media containing water as refrigerant.

The term ionic liquid refers to a salt or a mixture of salts composed of anions and cations, where the salt or the mixture of salts has a melting point of less than 100° C.

The term ionic liquid refers to salts or mixtures of salts which are free of nonionic materials or additives. The ionic liquid preferably consists of one or more salts of organic cations with organic or inorganic anions. The ionic liquid preferably has a melting point of less than 20° C. in order to avoid solidification of the ionic liquid in the sorption medium circuit when the working medium is used in an absorption heat pump.

Ionic liquids having anions of strong acids, preferably of acids having a pKa of less than 0, are suitable for the sorption medium of the invention. Suitable anions are nitrate, perchlorate, hydrogensulphate, anions of the formulae R^{a}OSO₃⁻ and R^{a}SO₃⁻, where R^{a} is a linear or branched aliphatic hydrocarbon radical having from 1 to 30 carbon atoms, a cycloaliphatic hydrocarbon radical having from 5 to 40 carbon atoms, an aromatic hydrocarbon radical having from 6 to 40 carbon atoms, an alkylaryl radical having from 7 to 40 carbon atoms or a linear or branched perfluoroalkyl radical having from 1 to 30 carbon atoms, and also anions of the formulae R^{a}OSO₃⁻ and R^{a}SO₃⁻ in which R^{a} is a polyether radical. The anion is preferably nitrate, hydrogensulphate, methanesulphonate, methylsulphate or ethylsulphate, particularly preferably methanesulphonate.

The organic cation or cations of the ionic liquid can be singly, doubly or multiply positively charged and are preferably singly positively charged. The organic cation or cations of the ionic liquid preferably have a molecular weight of not more than 260 g/mol, particularly preferably not more than 220 g/mol, in particular not more than 195 g/mol and most preferably not more than 170 g/mol. The limiting of the molar mass of the cation improves the outgassing range of the working medium during operation of an absorption heat pump.

Suitable organic cations are, in particular, cations of the general formulae (I) to (V):

R¹R²R³R⁴N⁺ (I)

R¹R²R³R⁴P⁺ (II)

R¹R²R³S⁺ (III)

R¹R²N⁺═C(NR³R⁴)(NR⁵R⁶) (IV)

R¹R²N⁺═C(NR³R⁴)(XR⁵) (V)

where

R¹, R², R³, R⁴, R⁵, R⁶ are identical or different and are each hydrogen, a linear or branched aliphatic hydrocarbon radical, a cycloaliphatic hydrocarbon radical, an aromatic hydrocarbon radical, an alkylaryl radical or a polyether radical of the formula —(R⁷—O)ₙ—R⁶, where in the case of cations of the formula (V) R⁵ is not hydrogen,

R⁷ is a linear or branched alkylene radical containing 2 or 3 carbon atoms,

n is from 1 to 3,

R⁸ is a linear or branched aliphatic hydrocarbon radical,

X is an oxygen atom or a sulphur atom and

at least one and preferably each of the radicals R¹, R², R³ R⁴, R⁵ and R⁶ is not hydrogen.

Cations of the formulae (I) to (V) in which the radicals R¹ and R³ together form a 4- to 10-membered, preferably 5- to 6-membered, ring are likewise suitable.

Further suitable cations are heteroaromatic cations having at least one quaternary nitrogen atom which bears a radical R¹ as defined above in the ring, preferably derivatives of pyrrole, pyrazole, imidazole, oxazole, isoxazole, thiazole, isothiazole, pyridine, pyrimidine, pyrazine, indole, quinoline, isoquinoline, cinnoline, quinoxaline or phthalazine which are substituted on the nitrogen atom.

The organic cation preferably contains a quaternary nitrogen atom. The organic cation is preferably a 1-alkylimidazolium ion, 1,3-dialkylimidazolium ion, 1,3-dialkylimidazolinium ion, N-alkylpyridinium ion, N,N-dialkylpyrrolidinium ion or an ammonium ion having the structure R¹R²R³R⁴N⁺, where R¹, R² and R³ are each, independently of one another, hydrogen or alkyl and R⁴ is an alkyl radical.

In a preferred embodiment, the organic cation is a 1,3-dialkylimidazolium ion, where the alkyl groups are preferably selected independently from among methyl, ethyl, n-propyl and n-butyl.

Preferred ionic liquids are 1,3-dimethylimidazolium methanesulphonate, 1-ethyl-3-methylimidazolium methanesulphonate, 1,3-diethylimidazolium methanesulphonate, 1,3-dimethylimidazolium methylsulphate, 1-ethyl-3-methylimidazolium methylsulphate, 1-ethyl-3-methylimidazolium ethylsulphate and 1,3-diethylimidazolium ethylsulphate. Particular preference is given to 1,3-dimethylimidazolium methanesulphonate, 1-ethyl-3-methylimidazolium methanesulphonate and 1,3-diethylimidazolium methanesulphonate, in particular 1,3-dimethylimidazolium methanesulphonate.

The ionic liquids can be prepared by processes known from the prior art, for example as described in P. Wasserscheid, T. Welton, Ionic Liquids in Synthesis, 2nd edition, Wiley-VCH (2007), ISBN 3-527-31239-0 or in Angew. Chemie 112 (2000) pages 3926-3945.

The ionic liquid is preferably liquid at 20° C. and at this temperature has a viscosity in accordance with DIN 53 019 of from 1 to 15 000 mPas, particularly preferably from 2 to 10 000 mPa·s, in particular from 5 to 5000 mPa·s and most preferably from 10 to 3000 mPa·s. At a temperature of 50° C., the ionic liquid preferably has a viscosity of less than 3000 mPa·s, particularly preferably less than 2000 mPa·s and in particular less than 1000 mPa·s.

Preference is given to using ionic liquids which have unlimited miscibility with water, are stable to hydrolysis and are thermally stable up to a temperature of 100° C.

Ionic liquids which are stable to hydrolysis display less than 5% degradation by hydrolysis in a mixture with 50% by weight of water during storage at 80° C. for 8000 hours.

Ionic liquids which are thermally stable up to a temperature of 100° C. display a weight decrease of less than 20% in a thermogravimetric analysis under a nitrogen atmosphere on heating from 25° C. to 100° C. at a heating rate of 10° C./min. Particular preference is given to ionic liquids which display a weight decrease of less than 10% and in particular less than 5% during the analysis.

The use of methanesulphonic acid as sorption medium in an absorption heat pump avoids the problem of sorption medium crystallization which occurs in the case of the sorption medium lithium bromide. Compared to sulphuric acid as sorption medium, methanesulphonic acid has the advantage of lower corrosiveness of the absorption medium. Compared to pure ionic liquids, methanesulphonic acid has the advantage of a lower viscosity and a high absorption capacity for water.

The sorption media of the invention which comprise methanesulphonic acid in combination with an ionic liquid make it possible to achieve a particularly good combination of low corrosiveness, low viscosity, high thermal stability of the sorption medium and high absorption capacity for water.

The following examples illustrate the invention, but without limiting the subject matter of the invention.

### EXAMPLES

### Examples 1 to 5

The vapour pressure of working media containing 15% by weight of water as refrigerant and 85% by weight of a sorption medium composed of methanesulphonic acid (MeSO₃H) and 1,3-dimethylimidazolium methanesulphonate (MMIM MeSO₃) was determined at 35° C. and 80° C. The proportions by weight of methanesulphonic acid and 1,3-dimethylimidazolium methanesulphonate examined and the results obtained are shown in Table 1.

TABLE 1
Vapour pressure of working media composed of 15% by weight
of water and 85% by weight of sorption medium

| | Proportions by | Vapour | Vapour |
|---|---|---|---|
| | weight in the | pressure at | pressure at |
| Example | sorption medium | 35° C. in mbar | 80° C. in mbar |
| 1 | 100% MeSO₃H | 1.3 | 10.5 |
| 2 | 58% MeSO₃H + | 6.8 | 100 |
| | 42% MMIM MeSO₃ | | |
| 3 | 50% MeSO₃H + | 9.2 | 115 |
| | 50% MMIM MeSO₃ | | |
| 4 | 20% MeSO₃H + | 12.1 | 136 |
| | 80% MMIM MeSO₃ | | |
| 5 | *100% MMIM MeSO₃ | 12.8 | 129 |

*not according to the invention

1. An absorption heat pump, comprising: an absorber; a desorber; a condenser; an evaporator; and a working medium comprising a volatile refrigerant and a sorption medium, wherein the sorption medium comprises methanesulphonic acid.

2. The absorption heat pump according to claim 1, wherein the absorption pump is an absorption refrigeration machine and the absorption pump takes up heat in the evaporator from a medium to be cooled.

3. The absorption heat pump according to claim 1, comprising water as refrigerant.

4. A sorption medium, comprising methanesulphonic acid and an ionic liquid.

5. The sorption medium according to claim 4, wherein the weight ratio of methanesulphonic acid to ionic liquids is in the range from 9:1 to 1:4.

6. The sorption medium according to claim 4, wherein the weight ratio of methanesulphonic acid to ionic liquids is in the range from 1:4 to 1:100.

7. The sorption medium according to claim 4, comprising a 1,3-dialkylimidazolium salt as ionic liquid.

8. The sorption medium according to claim 7, wherein the 1,3-dialkylimidazolium salt is selected from among the group consisting of 1,3-dimethylimidazolium methanesulphonate, 1-ethyl-3-methylimidazolium methanesulphonate and 1,3-diethylimidazolium methanesulphonate.

9. The absorption heat pump according to claim 1, comprising a sorption medium comprising methanesulphonic acid and an ionic liquid.

10. A process, comprising employing methanesulphonic acid as sorption medium in an absorption heat pump.

11. The process according to claim 10, wherein the absorption heat pump is an absorption refrigeration machine comprising an evaporator, and wherein in the evaporator heat is taken up from a medium to be cooled.

12. The process according to claim 10, wherein methanesulphonic acid is in the form of a sorption medium comprising methanesulphonic acid and an ionic liquid.
